(19) United States
(12) Patent Application Publication
(10) Pub. No.: US 2007/0252854 A1
(43) Pub. Date: Nov. 1, 2007

(54) AUDIO VISUAL SYSTEM AND ROTATING UNIT THEREOF

(75) Inventor: Satoshi Ueno, Osaka (JP)

Correspondence Address: GLOBAL IP COUNSELORS, LLP, 1233 20TH STREET, NW, SUITE 700, WASHINGTON, DC, 20036-2680, US

(73) Assignee: Funai Electric Co., Ltd., Osaka (JP)

(21) Appl. No.: 11/738,810

(22) Filed: Apr. 23, 2007

(30) Foreign Application Priority Data
Apr. 26, 2006 (JP) 2006-122265

(51) Int. Cl. G09G 5/00

(52) U.S. Cl. 345/649

(57) ABSTRACT

An audio visual system includes a display unit, a sound unit and a rotating unit. The display unit is configured to be rotated horizontally by receiving a control signal. The sound unit includes a center speaker and a side speaker. The center speaker is disposed at the display unit and rotated together with the display unit. The side speaker is disposed apart from the display unit. The rotating unit includes a rotating base and a control section. The rotating base is configured to support the side speaker. The control section is configured to rotate the rotating base together with the side speaker horizontally in synchronization with the display unit based on the control signal.

### CROSS-REFERENCE TO RELATED APPLICATIONS

This application claims priority to Japanese Patent Application No. 2006-122265 filed on Apr. 26, 2006. The entire disclosure of Japanese Patent Application No. 2006-122265 is hereby incorporated herein by reference.

### BACKGROUND OF THE INVENTION

1. Field of the Invention

The present invention relates to an audio visual system. More specifically, the present invention relates to an audio visual system including a display unit having a horizontal rotational function.

2. Background Information

A conventional home theater system or other such audio visual system includes a display unit having a horizontal rotational function and a sound unit connected to the display unit. The sound unit includes a center speaker and left and right speakers. The center speaker is disposed on a front side of the display unit. The center speaker is rotated with the display unit. The left and right speakers are disposed apart from each other on left and right sides of the display unit.

When the display unit is rotated horizontally, the center speaker of the sound unit is also rotated horizontally together with the display unit. Therefore, an audio output direction from the center speaker differs from audio output directions from the left and right speakers. This diminishes an optimal surround sound experience.

In view of the above, it will be apparent to those skilled in the art from this disclosure that there exists a need for an improved audio visual system. This invention addresses this need in the art as well as other needs, which will become apparent to those skilled in the art from this disclosure.

### SUMMARY OF THE INVENTION

The present invention was conceived in light of the above situation. One object of the present invention is to provide an audio visual system with which an appropriate surround sound experience is obtained even when a display unit has been rotated horizontally.

In accordance with one aspect of the present invention, an audio visual system includes a display unit, a sound unit and a rotating unit. The display unit is configured to be rotated horizontally by receiving a control signal. The sound unit includes a center speaker and a side speaker. The center speaker is disposed at the display unit and rotated together with the display unit. The side speaker is disposed apart from the display unit. The rotating unit includes a rotating base and a control section. The rotating base is configured to support the side speaker. The control section is configured to rotate the rotating base together with the side speaker horizontally in synchronization with the display unit based on the control signal.

When the display unit is rotated horizontally to a desired angle, the center speaker of the sound unit is also rotated horizontally together with the display unit. Furthermore, the rotating base rotates the side speaker in synchronization with the display unit to the desired angle. Therefore, an audio output direction from the center speaker and an audio output direction from the side speaker are oriented in the same desired direction. Accordingly, an appropriate surround sound experience is obtained even when the display unit has been rotated.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 illustrates an oblique view of an audio visual system;

FIG. 2 is a block diagram of the audio visual system;

FIG. 3 is a plan view of a state in which the audio visual system is facing forward;

FIG. 4 is a plan view of a state in which the audio visual system is angled to the left;

FIG. 5 is a plan view of a state in which the audio visual system is angled to the right;

FIG. 6 is an oblique view of a rotating base;

FIG. 7 is a plain view of the rotating base;

FIG. 8 is a side view of the rotating base;

FIG. 9 is a bottom view of the rotating base;

FIG. 10 is a sectional view of the rotating base;

FIG. 11 is an enlarged view of the rotating base;

FIGS. 12A-12F are plain views of the audio visual system explaining an initial setting of the audio visual system;

FIG. 13 is a flow chart of the initial setting of the audio visual system; and

FIG. 14 is a bottom view of a rotating base in accordance with a second embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

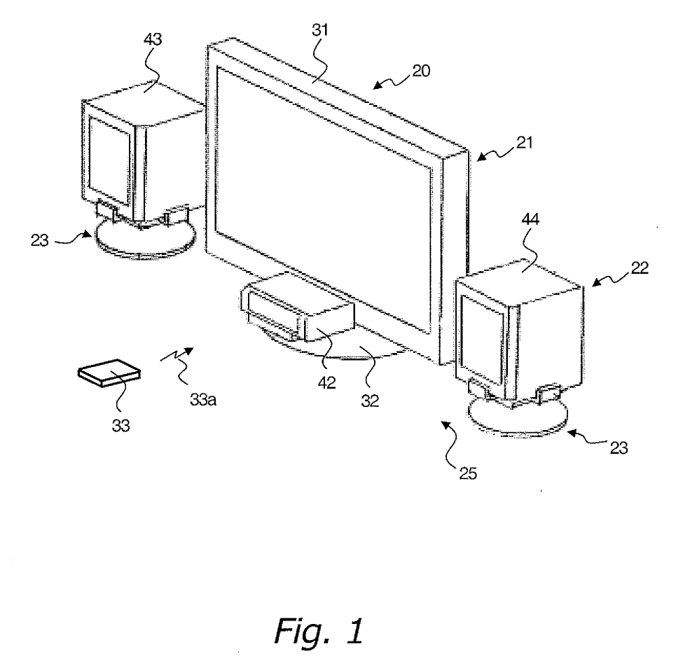

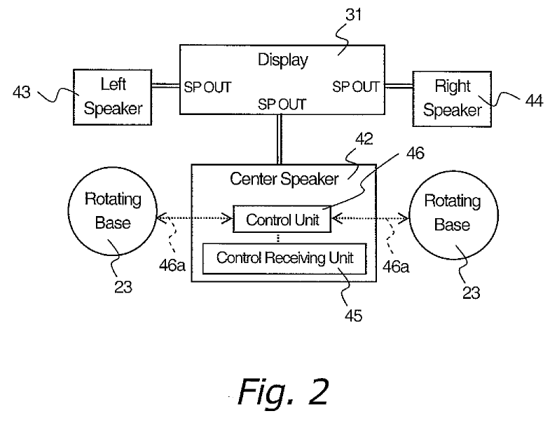

Referring to FIGS. 1 and 2, an audio visual system 20 is illustrated in accordance with a first embodiment of the present invention. The audio visual system 20 includes a display unit 21, a sound unit 22 and rotating bases (or left and right rotating bases) 23.

The display unit 21 has a display 31 and a display rotating base 32. The display 31 displays video and outputs several sound channels (SP OUT) to the sound unit 22. The display rotating base 32 supports the display 31 as a stand. The display rotating base 32 has a horizontal rotational function for rotating the display 31 horizontally within a predetermined rotating range (or a swivel angle). Specifically, the display rotating base 32 is controlled by a remote control 33 and rotates the display 31 by receiving a horizontal rotation signal (or control signal) 33a from the remote control 33.

The sound unit 22 is electrically connected to the display unit 21. The sound unit 22 receives the sound channels from the display 31 to play sound. The sound unit 22 has a center speaker 42 and left and right speakers (or side speakers) 43 and 44.

The center speaker 42 is disposed on a front side of the display 31 and rotated with the display 31. The center speaker 42 receives a center sound channel from the display 31 and outputs the center sound channel. Referring to FIG. 2, the center speaker 42 includes a control receiving unit (or control signal receiving section) 45 and a control unit (or control section) 46. The control receiving unit 45 receives the horizontal rotation signal 33a from the remote control 33. The control unit 46 outputs horizontal rotation control signals 46a to the rotating bases 23 so that the rotating bases 23 rotate the left and right speakers 43 and 44 in synchronization with the display 31 and the center speaker 42.

The control unit 46 preferably includes a microcomputer with a control program that controls the rotating bases 23 and an initial setting program for initially setting a rotation speed of the rotating bases 23. It will be apparent to one of ordinary skill in the art from this disclosure that the control unit 46 can also include other conventional components such as an input interface circuit, an output interface circuit, and storage devices such as a ROM (Read Only Memory) device and a RAM (Random Access Memory) device. The microcomputer of the control unit 46 is programmed to control the rotating bases 23 based on the horizontal rotation signal 33a received by the control receiving unit 45. A memory circuit stores processing results and programs such as ones for the audio visual system 20. It will be apparent to one of ordinary skill in the art from this disclosure that the precise structure and algorithms for control unit 46 can be any combination of hardware and software that will carry out the functions of the present invention.

The left and right speakers 43 and 44 are disposed apart from each other on left and right sides of the display 31. Furthermore, the left and right speakers 43 and 44 are disposed on the rotating bases 23, respectively. The left and night speakers 43 and 44 receive left and right sound channels from the display 31 and output the left and right sound channels, respectively.

The control receiving unit 45, the control unit 46 and the rotating bases 23 constitute a rotating unit 25.

The rotating bases 23 are disposed apart from each other on left and right sides of the display 31 and support the left and right speakers 43 and 44, respectively. The rotating bases 23 receive the horizontal rotation control signals 46a and rotate the left and right speakers 43 and 44, respectively. The bases 23 are separate from the display rotating base 32.

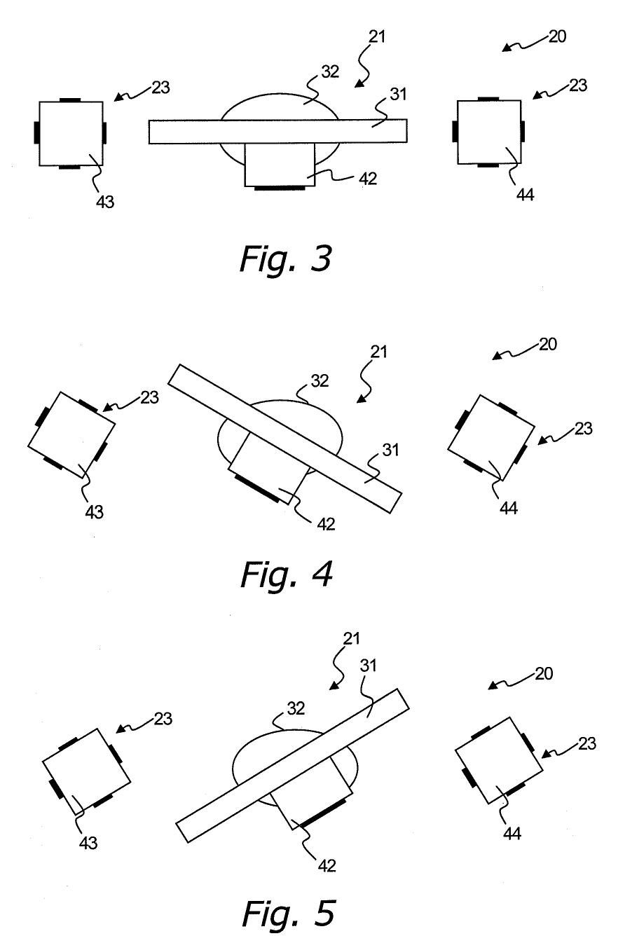

As shown in FIGS. 3-5, with the audio visual system 20, when the display 31 of the display unit 21 is rotated horizontally to a desired angle, the center speaker 42 of the sound unit 22 is also rotated horizontally together with the display 31. Furthermore, the rotating bases 23 rotate the left and right speakers 43 and 44 to the desired angle in the same horizontal direction in synchronization with the display 31. Therefore, an audio output direction from the center speaker 42 and audio output directions from the left and right speakers 43 and 44 are oriented in the same desired direction. Accordingly, an optimal surround sound experience is obtained even when the display 31 is rotated. Rotating Bases 23 & Initial Setting of the Rotating Bases 23

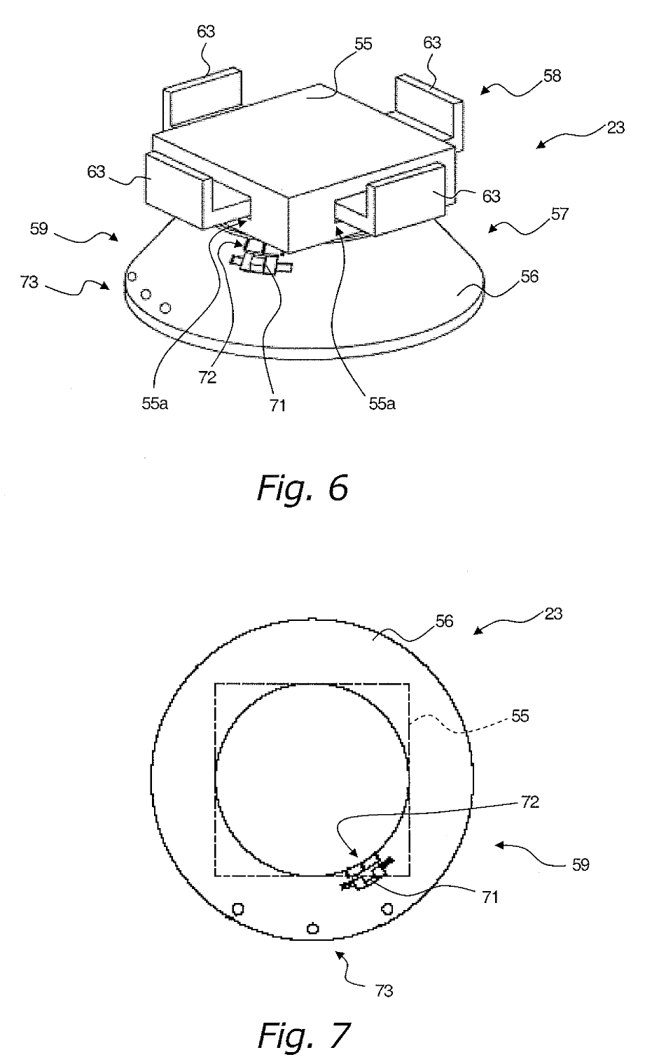

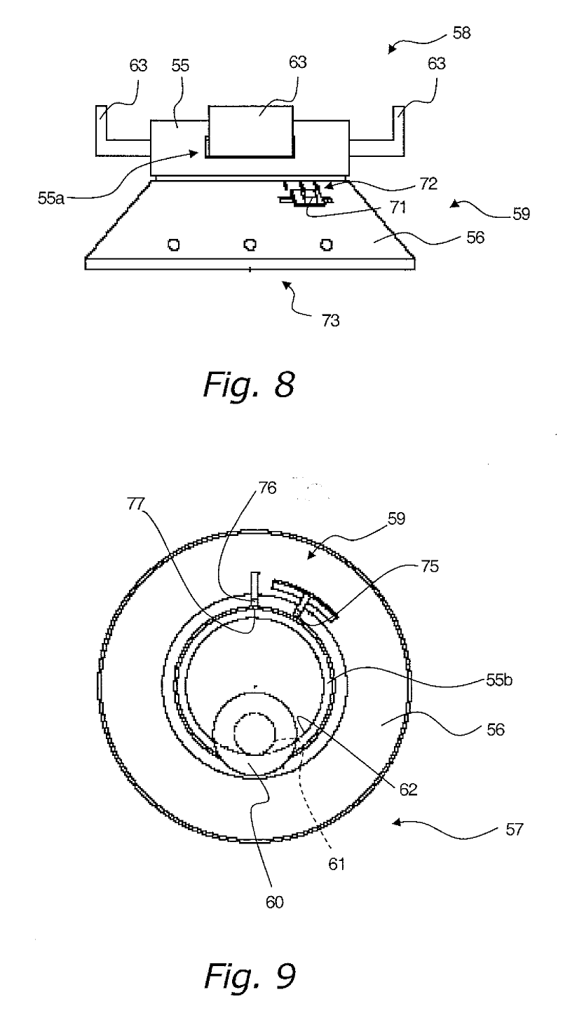

Referring to FIGS. 6-11, the detailed structure of the rotating bases 23 will be described. Each of the rotating bases 23 has a stage 55, a stand 56, a horizontal rotation mechanism (or rotation mechanism) 57, a speaker support mechanism 58 and a rotation detecting section 59. The stage 55 is rotatably supported by the stand 56.

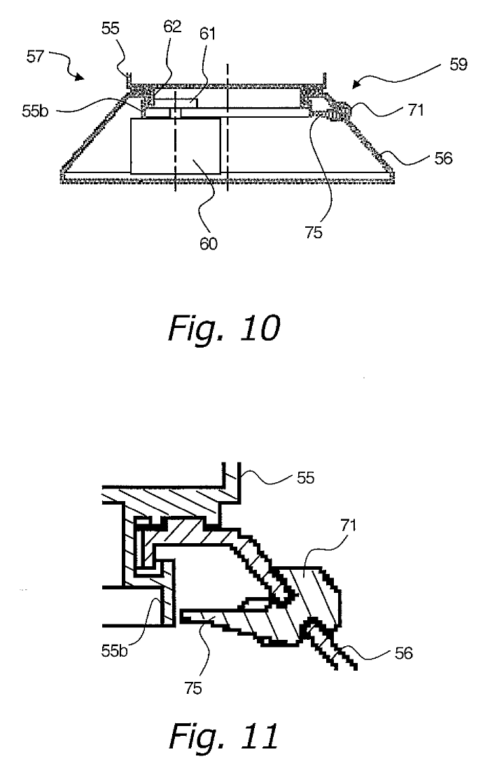

The horizontal rotation mechanism 57 is disposed between the stand 56 and the stage 55. The horizontal rotating mechanism 57 is configured to rotate the stage 55 with respect to the stand 56. Referring to FIGS. 9 and 10, the horizontal rotation mechanism 57 includes a drive motor 60, a gear portion 61 and an internal tooth portion (or tooth portion) 62. The drive motor 60 is fixed to an inner side of the stand 56. The drive motor 60 is driven by the horizontal rotation control signal 46a outputted by the control unit 46. The gear portion 61 includes one or more gears and is attached to the drive motor 60. The internal tooth portion 62 has internal teeth formed on an inner circumference of a bottom portion 55b of the stage 55 and meshes with the gear portion 61.

The speaker support mechanism 58 is configured to support the left and right speakers 43 and 44 disposed on the stage 55. The speaker support mechanism 58 includes L-shaped support tabs 63 slidably attached to four sides of the stage 55. The support tabs 63 are width-adjustable with respect to the stage 55. Tension springs (not shown) are installed between the proximal end of each of the support tabs 63 and an inside of holes 55a formed in the stage 55 to inwardly bias the support tabs 63.

Since the support tabs 63 on the four sides of the stage 55 are width-adjustable with respect to stage 55, the width of the support tabs 63 can be adjusted to fit the sizes of the left and right speakers 43 and 44. This allows the left and right speakers 43 and 44 to be supported more securely.

The rotation detecting section 59 detects a rotational position of the stage 55 with respect to the stand 56. The rotation detecting section 59 includes a knob 71, a rotational end detecting sensor 75, a rotational center detecting sensor 76 and a rotational position indicator 77. The knob 71 is slidably attached to an outside of the stand 56. The knob 71 is configured to set a rotational end angle (or a swivel angle) to a desired angle by being placed at a position where an angle scale 72 indicates the desired angle. The angle scale 72 is formed on the stand 56 and indicates angles (e.g. 20, 25, 30, 35 and 40 degrees).

Referring to FIGS. 9-11, the rotational end detecting sensor 75 is configured to detect that the stage 55 is positioned at a rotational end by detecting the rotational position indicator 77. The rotational end detecting sensor 75 is disposed on a distal end of the knob 71. The rotational center detecting sensor 76 is configured to detect that the stage 55 is positioned at a center position of a rotational range by detecting the rotational position indicator 77. The rotational center detecting sensor 76 is disposed at an inner surface of the stand 56. The rotational position indicator 77 includes a slit formed at the bottom portion 55b of the stage 55 by cutting out the bottom portion 55b of the stage 55. The rotational end detecting sensor 75 and the rotational center detecting sensor 76 are disposed opposite to an outer circumference of the bottom portion 55b of the stage 55. When the rotational position indicator 77 is positioned opposite to the rotational end detecting sensor 75 or the rotational center detecting sensor 76, the rotational end detecting sensor 75 or the rotational center detecting sensor 76 outputs a signal to the control unit 46 of the center speaker 42. Also, the signal from the rotational end detecting sensor 75 or the rotational center detecting sensor 76 makes one of LEDs 73 light up. The LEDs 73 indicate which sensor 75 or 76 detects the rotational position indicator 77.

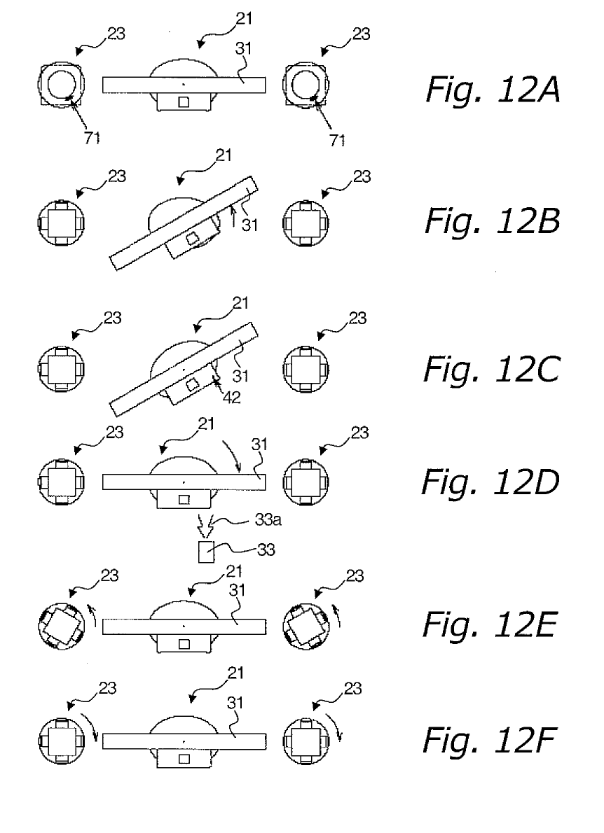

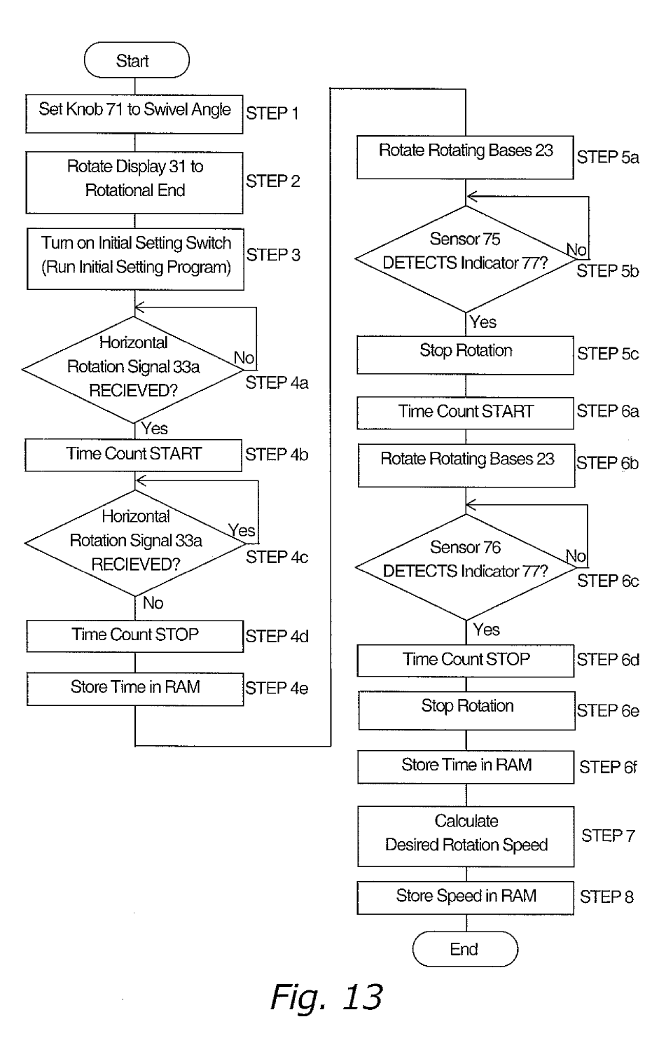

Referring to FIGS. 12A-12F and 13, an initial setting of the rotating bases 23 will be described. In the initial setting of the rotating bases 23, a rotational speed of the rotating bases 23 is adjusted to a rotational speed of the display unit 21. First, as shown in FIG. 12A, the knob 71 is set to an angle corresponding to a swivel angle of the display unit 21 (STEP 1). Then, as shown in FIG. 12B, the display 31 is rotated to a rotational end by the remote control 33 or by hand (STEP 2). After the STEP 2, as shown in FIG. 12C, an initial setting switch (not shown) disposed at the center speaker 42 is turned on so that the control unit 46 runs the initial setting program stored in the control unit 46 (STEP 3).

As shown in FIG. 12D, the display 31 is rotated to a center position by the remote control 33, and the initial setting program counts a receiving time for receiving the horizontal rotation signal 33a from the remote control 33 and stores the receiving time in the RAM of the control unit 46 (STEPS 4a-4e). After the display 31 is positioned to the center position by the remote control 33, as shown in FIG. 12E, the rotating bases 23 are rotated automatically in one direction (e.g. counter-clockwise direction) until the rotational end detecting sensor 75 detects the rotational position indicator 77 (STEPS 5a-5c). After the rotational end detecting sensor 75 detects the rotational position indicator 77, as shown in FIG. 12F, the rotating bases 23 are rotated automatically at a default speed in the other direction (e.g. clockwise direction) until the rotational center detecting sensor 76 detects the rotational position indicator 77. While the rotating bases 23 are rotated, the initial setting program counts a rotation time of the rotating bases 23 from the rotational end to the center of the rotation and stores the rotation time in the RAM of the control unit 46 (STEPS 6a-6f). Then, the initial setting program compares the receiving time counted in the STEPS 4a-4e and the rotation time counted in the STEPS 6a-6f and calculates a desired rotation speed of the rotating bases 23 by multiplying the default rotation speed by a rate of the rotation time to the receiving time (STEP 7). The desired rotation speed derived in STEP 7 corresponds to the rotation speed of the display unit 21. The control unit 46 stores the calculated desired rotation speed in the RAM and the control unit 46 ends the initial setting program (STEP 8). After setting the desired rotation speed of the rotating bases 23, the control unit 46 controls the rotating bases 23 so that the rotating bases 23 rotate at the desired rotation speed in synchronization with the display unit 21.

Since the audio visual system 20 initially sets the rotation speed of the rotating bases 23 to the rotation speed of the display unit 21, the rotating bases 23 rotate the left and right speakers 43 and 44 in synchronization with the display 31 and the center speaker 42 disposed to the display 31. Therefore, an audio output direction from the center speaker 42 and audio output directions from the left and right speakers 43 and 44 are oriented in the same desired direction. Accordingly, an optimal surround sound experience is obtained even when the display 31 is rotated.

### Second Embodiment

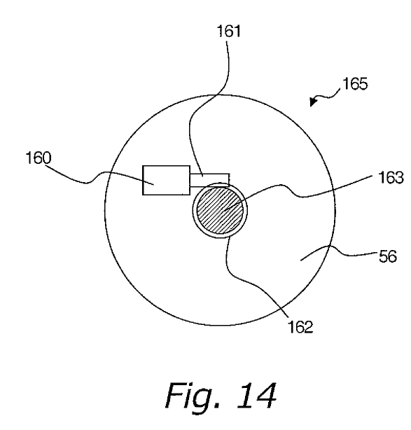

Referring now to FIG. 14, a horizontal rotation mechanism 165 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

As shown in FIG. 14, each of the rotating bases 23 may have a horizontal rotation mechanism 165 having a drive motor 160, a gear portion 161 and an external tooth portion 162 (or tooth portion). The drive motor 160 is fixed to an inner side of the stand 56 and is driven by the horizontal rotation control signal 46a outputted by the control unit 46. The gear portion 161 includes one or more gears and is attached to the drive motor 160. The external tooth portion 162 has external teeth formed on an outer circumference of a rotational axel 163 of the stage 55 and meshes with the gear portion 161. With this arrangement, the stage 55 is reliably rotated with respect to the stand 56 by being driven by the drive motor 160.

The display unit 21 may be equipped with the horizontal rotation mechanism 57 or 165 between the display 31 and the display rotating base 32.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of an audio visual system equipped with the present invention. Accordingly, these terms, as utilized to describe the present invention should be interpreted relative to an audio visual system equipped with the present invention as used in the normal viewing position. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An audio visual system comprising:
a display unit configured to be rotated horizontally by receiving a control signal;
a sound unit having a center speaker disposed at the display unit and rotated together with the display unit, and a side speaker disposed apart from the display unit; and
a rotating unit having a rotating base configured to support the side speaker and a control section configured to rotate the rotating base together with the side speaker horizontally in synchronization with the display unit based on the control signal.

2. The audio visual system according to claim 1, wherein
the center speaker is attached at a front side of the display unit, and
the control section is attached to the center speaker.

3. The audio visual system according to claim 2, wherein
the rotating unit further has a control signal receiving section attached to the center speaker and configured to receive the control signal and output the control signal to the control section.

4. The audio visual system according to claim 3, wherein
the control signal is received from a remote control.

5. The audio visual system according to claim 1, wherein
the rotating base includes support tabs slidably disposed at the rotating base and configured to hold the side speaker horizontally.

6. The audio visual system according to claim 5, wherein
the support tabs are provided at four sides of the rotating base and are width-adjustable with respect to the rotating base.

7. The audio visual system according to claim 1, wherein
the control section is configured to adjust a rotation speed of the rotating base based on the control signal so that the rotating base rotates the side speaker in synchronization with the display unit.

8. The audio visual system according to claim 1, wherein
the side speaker includes left and right speakers disposed apart from each other on left and right sides of the display unit.

9. The audio visual system according to claim 8, wherein
the rotating base includes left and right rotating bases configured to support the left and right speakers, respectively.

10. The audio visual system according to claim 1, wherein
the rotating base includes a stand, a stage rotatably attached to the stand and a rotation mechanism disposed between the stand and the stage and configured to rotate the stage with respect to the stand, and
the rotation mechanism includes a drive motor attached to the stand, a gear portion driven by the drive motor and a tooth portion configured to mesh with the gear portion.

11. A rotating unit for an audio visual system having a display unit configured to be rotated horizontally by receiving a control signal, comprising:
a rotating base configured to support a side speaker of a sound unit; and
a control section configured to rotate the rotating base together with the side speaker horizontally in synchronization with the display unit based on the control signal.

12. The rotating unit according to claim 11, wherein
the control section is configured to be attached to a center speaker of the sound unit.

13. The rotating unit according to claim 12, further comprising
a control signal receiving section is configured to be attached to the center speaker and configured to receive the control signal and output the control signal to the control section.

14. The rotating unit according to claim 13, wherein
the control signal is received from a remote control.

15. The rotating unit according to claim 11, wherein
the rotating base includes support tabs slidably disposed at the rotating base and configured to hold the side speaker horizontally.

16. The rotating unit according to claim 15, wherein
the support tabs are provided at four sides of the rotating base and are width-adjustable with respect to the rotating base.

17. The rotating unit according to claim 11, wherein
the control section is configured to adjust a rotation speed of the rotating base based on the control signal so that the rotating base rotates the side speaker in synchronization with the display unit.

18. The rotating unit according to claim 11, wherein
the side speaker includes left and right speakers disposed apart from each other on left and right sides of the display unit.

19. The rotating unit according to claim 18, wherein
the rotating base includes left and right rotating bases configured to support the left and right speakers, respectively.

20. The rotating unit according to claim 11, wherein
the rotating base includes a stand, a stage rotatably attached to the stand and a rotation mechanism disposed between the stand and the stage and configured to rotate the stage with respect to the stand, and
the rotation mechanism includes a drive motor attached to the stand, a gear portion driven by the drive motor and a tooth portion configured to mesh with the gear portion.
